(19) United States
(12) Patent Application Publication
(10) Pub. No.: US 2021/0078208 A1
(43) Pub. Date: Mar. 18, 2021

(54) Plant and method for the online recovery of trimmings in extrusion lines of film made of plastic material

(71) Applicant: Colines S.p.A., Novara (IT)

(72) Inventor: Nicola Lombardini, Oleggio (NO) (IT)

(21) Appl. No.: 15/733,526

(22) PCT Filed: Mar. 12, 2019
(86) PCT No.: PCT/IB2019/051999

§ 371 Date: Aug. 20, 2020

(30) Foreign Application Priority Data
Mar. 26, 2018 (IT) 102018000003921

(51) Int. Cl. B29B 17/00; B29B 17/04; B29C 48/00; B29C 48/08; B29C 48/14; B29C 48/275; B29C 48/285; B29C 48/355; B29C 48/50

(52) U.S. Cl. CPC B29B 17/0005; B29B 17/0412; B29C 48/0022; B29C 48/08; B29C 48/143; B29K 2105/26; B29C 48/287; B29C 48/288; B29C 48/297; B29C 48/355; B29C 48/501; B29C 48/277

(57) ABSTRACT

A plant and method for the online recovery of trimmings generated in an extrusion line of a plastic film includes a cutting apparatus configured to cut side portions, also called trimmings, from the plastic film made leaving a forming apparatus of the plastic film; a conveying apparatus, positioned downstream of the cutting apparatus, that conveys the trimmings; an extruder for treatment of the trimmings; and an apparatus dosing and feeding granules for forming the plastic film made in the extruder, the extruder and the apparatus dosing and feeding the granules being positioned upstream of the forming device. An apparatus for pre-treatment of the trimmings is provided at the inlet of the extruder and includes a shredder positioned coaxially with respect to the extruder.

The present invention relates to a plant for the online recovery of trimmings in extrusion lines of film made of plastic material.

The invention also relates to a method for the online recovery of trimmings in extrusion lines of film made of plastic material.

The production of plastic film having a relatively low thickness (commonly called “film”) suitable for flexible packaging, both domestic and industrial, has been growing almost constantly for several decades, and together with the quantitative request, the quality of the product is constantly evolving and specializing.

Evidence of this lies in the fact that during these years various types of production plants have been introduced on the market, to cover the needs of the end users as much as possible.

The type of film referred to in this description, in particular, generally (but not exclusively) has a variable thickness ranging from a few microns (even 5÷6 microns) up to about 500 microns, the limit above which the term “sheet” is mainly used for identifying this group of products and which has a production technology substantially different from what is meant in this context.

One of the greatest limitations of any type of plant for the production of plastic film, however, concerns the treatment and recovery of the so-called “trimmings”, i.e. that portion of film typically positioned (but again not exclusively) laterally with respect to the same, which, for various reasons intrinsically linked to the production process (whatever it may be), cannot be used as it does not correspond to the characteristics of the rest of the plastic film.

The percentage incidence of this part of film that cannot be used directly can vary from a few percent (in any case not less than 3-4%) up to percentages that can even reach 35-40% of the film produced.

In some specific cases, but which still represent a minority share, these trimmings cannot be reused in any way in the same process, as, for example, they are composed of materials that should be separated from each other to be used again thereafter (as in the production of so-called “barrier” film, or in the case of films coupled with non-plastic elements such as paper or aluminium), but even if these materials can actually be reused, their use always involves a series of steps and processes that cause either a deterioration in the characteristics of the material itself or a basic difficulty in the management, hardly compatible with an industrial production line.

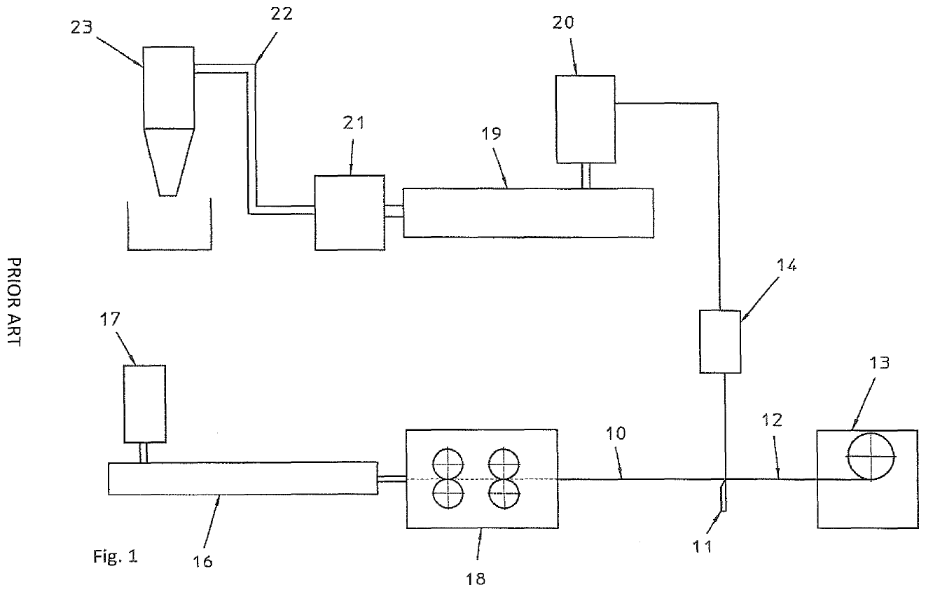

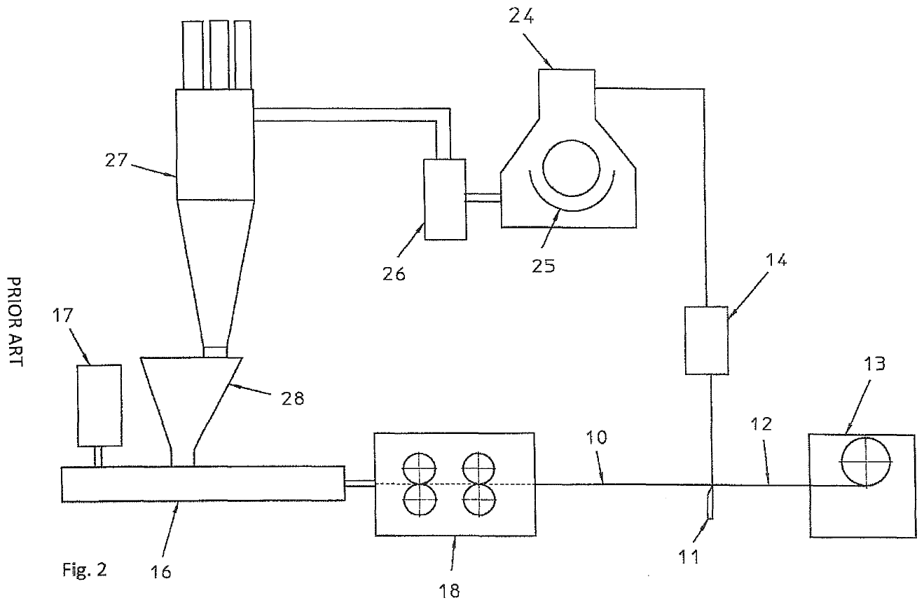

More specifically, the current state of the art provides two systems for managing and recovering trims that are clearly predominant, both in terms of diffusion and efficiency, compared to other less well-known systems:
recovery by regranulation (or “regeneration”) of the trimmings in a specific extruder (FIG. 1);
recovery by grinding of the trimmings in a so-called “mill” and subsequent feeding into an extruder of the production line by means of suitable systems (FIG. 2).

Both cases have advantages and criticalities, which will be discussed hereunder, which at present have not yet been resolved.

The recovery system of trimmings through a regranulation extruder basically consists in conveying the trimming from the extrusion line (from which it is cut by means of any cutting system 11, a blade or a circular blade or a pressure blade, or other) by means of any transporting system 14 to an actual extruder 19; generically but not exclusively, transporting systems can be used by applying the Venturi concept, or with crossing fans or again (depending on the type of film being produced, and in particular compatibly with its thickness and production speed) through a series of motorized haulers and cylinders.

The trimmings, which can be continuous or previously “broken up” by means of well-known systems generally called “multi-cutters” 20, can then be fed directly into the extruder, which, by means of a screw with a particular geometry (however variable depending on the extruder manufacturer and the type of material to be regenerated), melts the material thus received, pushing it into an extrusion die 21 characterized by a series of holes (typically but not exclusively round in shape) through which a series of so-called “spaghetti” are extruded.

At the exit of said die, there is generally (but not exclusively) a sort of rotating blade, which breaks up the spaghetti, generating small granules whose size can be varied along the extrusion direction by suitably managing the speed and/or the number of said rotating blade, and in terms of diameter (or side) using a die characterized by holes having a size suitable for the purpose.

Depending on the extruder flow-rate and type of material to be regenerated (and therefore its operating temperature), the cooling of these granules (which are obviously produced in the molten state, or in any case at temperatures close to the Vicat temperature of the polymeric material processed) can be effected either using a fan which, by conveying the material for a more or less lengthy stretch in specially prepared pipes 22, provides for its cooling, or using a so-called “water bath”, where the granules are caused to “fall” in order to be cooled in a short time.

After cooling in said bath, the granules are also in this case conveyed by means of a fan/compressor (typically but not exclusively) along a section previously prepared for providing for their drying, to be then decanted (as in the previous case) in a cyclone 23 or through any other air and particle separation system (in this case the granules).

The greatest and most obvious limits of this process can be easily identified:

1—The high energy consumption, as it is a process that is absolutely comparable to a “normal” extrusion and which, as indicated, can also affect several percent of the total production line capacity.
2—The need for an operator with an almost constant presence near the extruder, which is essentially a real production line, often positioned in an adjacent environment but not common to that where the “actual” production line is positioned, as it is a source of dust and various types of dirt.
3—The (extremely concrete) risk of degrading the material processed, especially from a physical-chemical point of view, due to the further plasticization process to which it is subjected before being reused in the production line; in particular, it is extremely frequent, if not constant, to see a change in the MFI (Melt Flow Index) value, which is an index that characterizes the viscosity of the material in the molten state that is crucial for characterizing the final product and its compatibility with any other possible resins used in the mixture.
4—The need for having a water cooling circuit (or any other fluid suitable for the purpose) in the case of extruders for high productions or for the re-granulation of raw materials that require particularly high operating temperatures.
5—The very frequent use of a water cooling system brings with it another obvious problem; in the case of the use of materials of a hygroscopic nature (such as for example polyamide, or Nylon, or materials containing inorganic fillers such as calcium carbonate CaCO₃), it is therefore necessary to also provide for a subsequent drying system of the granule thus produced, with a further (and considerable) energy consumption.
6—The dimensions, at times even quite significant, of the whole plant (conveying the trimmings+extruder+extrusion die+cutting at the head+possible water cooling+possible drying system+conveying the granule), as can be seen from FIG. 1, which requires the use of a room of the production area to be dedicated exclusively for this equipment.
7—Last but not least, the considerable difficulty in guaranteeing a constant supply to the extruder, as almost all of the transporting systems of the trimmings use air as a vector, which, as is well known, is difficult to “manage” and which can therefore easily generate turbulence phenomena which make the conveying of the trimming, and therefore its feeding into the extruder, inconstant; the logical consequence of this instability is the generation of heavy variations in the flow-rate of the regeneration extruder, with the consequent production of granules also having substantially different dimensions.

This fact is detrimental to the subsequent reusability of the granule thus produced, as a considerable variation in the particle size of the material significantly changes its apparent density, it therefore considerably influences the feeding regularity of said granule in a normal production line.

This latter disadvantage can be solved through the interpositioning of a grinding mill, of any shape or size, immediately upstream of the regeneration extruder; with this arrangement it is possible to regularize the feeding of the same extruder, as said mill grinds the trimming, damping any possible flow irregularities and thus guaranteeing a correct feeding.

The recovery system of the trimmings by grinding the same in a suitable grinding mill is described in FIG. 2 and basically consists in conveying the trimming from the extrusion line (from which it is cut by means of any cutting system 11, using a cutting blade or with a circular blade or pressure blade, or other) by means of any transporting system 14 to a mill 24; generally but not exclusively, transporting systems can be used by applying the Venturi concept, or with crossing fans or again (depending on the type of film being produced, and in particular compatibly with its thickness and production rate) by means of a series of motorized haulers and cylinders.

The trimmings, which can be continuous or previously “broken up” by means of well-known systems, generically called “multi-cutters”, are then fed directly into a so-called mill 24, or a rotor equipped with a series of blades that rotate at a fixed or variable speed around its axis; a series of fixed blades are arranged circumferentially with respect to this rotor, at a very close distance from those mounted on the rotor (typically but not exclusively this distance is equal to 0.05÷0.5 mm), therefore the trimming, passing through this meatus, is subjected to a scissor cut.

In a position below this rotor, a kind of “grid” 25 is generally (but not always) provided, which can have passage holes of various shapes and sizes (typically from a few mm up to a few cm), which allows the passage of “pieces” of film only when they have reached the minimum size for allowing their passage.

The result of this operation is therefore the generation of a series of “confetti”, commonly called “fluff”, starting from the continuous trimming (or previously broken up), whose apparent density, in any case much lower than that of the virgin or regenerated granule, can also vary significantly depending on the size of the pieces, in turn linked, as is obvious, to the size of the passage holes of said grid.

In any case, even at best, the apparent density of said fluff never exceeds the value of 0.05÷0.10 kg/dm³, against an apparent density value of the granule which on the other hand is generally about 0.55÷0.60 kg/dm³.

As can be seen, therefore, the difference in terms of density (and consequently of committed volume) between the two forms is approximately one order of magnitude.

During the grinding operation of the trimmings, there is naturally the production of heat, or heating of the fluff, due to the cutting action of the blades; in any case, the mill must be sized and designed in such a way that this heating never brings the material to softening temperature, i.e. it always remains in the solid state and therefore does not vary its molecular structure (consequently not undergoing any risk of degradation).

This fluff is then conveyed by means of any system 26 from the mill to the extruder 16 (or to the extruders) of the production line, where it is generally, but not exclusively, discharged by means of a cyclone 27 and then fed into the extruder 16 by different means, which can range from a simple conveyor screw 28 to more complex rotating channel systems; in any case, these systems have as common denominator the purpose of increasing the density of the fluff until it becomes (hopefully) comparable to that of the granule, or at least with the same order of magnitude, providing, at the same time, a (partial) mixing of these elements.

The greatest and most obvious limits of this process can be easily identified:

1—The grinding of the trimmings inevitably generates dust, subsequently conveyed by the system 26, which must in some way be separated from the rest of the fluff so as not to cause problems relating to the subsequent extrusion in the production line; dedusting systems are therefore necessary, which can have the most varied forms (simple discharge hoses, automatic de-dusting systems, etc.), but which in any case require maintenance and periodic “emptying”, otherwise the performance can be drastically reduced in terms of dedusting resulting in a deterioration in the quality of the final film.
2—The main problem undoubtedly relates to the re-feeding of said ground product into the extruder (or extruders) of the production line, mainly due to the considerable difference in apparent density with respect to the virgin granule; any system used must however provide for the generation of a “hydraulic seal” on the mouth of the extruder sufficiently high for bringing the apparent density of the fluff to levels similar to those of the granule, but in any case these are systems that base their own functioning principle on the friction generated on the fluff by a rotating element.
3—It therefore becomes particularly complicated to guarantee the correct feeding constancy to the extruder (or extruders) of the production line, especially when the film to be ground is composed in turn of different materials which can therefore have behaviours that are also substantially different from each other; this inevitably leads to a considerable difficulty in ensuring a correct production consistency of the final product.
4—The overall dimensions of the entire system are considerable, as can be seen from FIG. 2, and furthermore the inevitable generation of dust during the process often (if not always) requires the use of a separate room for this system, to avoid polluting the production process of the finished product with said powder.

The general objective of the present invention is to overcome the drawbacks of the known art and, in view of this objective, according to the invention, the application of a plant and a recovery method has been conceived, which allows the maximum regularity of feeding and, at the same time, the absolute absence of risk of degradation of the material.

This objective is achieved with a method and a plant produced according to the enclosed claim 1 and subclaims.

In particular, the present invention provides for the use of an extruder for regeneration, not as a unit in itself, but as part of the production line, i.e. the same being in charge of the production of part of the final product (or a “layer” of the same).

In other words, as almost all the films produced are characterized by a plurality of layers (not less than two, very often more than three), the production lines are consequently equipped with a similar plurality of extruders, typically (but not exclusively) used for the production of a single layer (but also a plurality of layers); the invention aims at “replacing” one of the aforementioned extruders with a homologous extruder suitable for the direct processing of trimmings, which therefore participates directly in the production of part of the finished product and not only of granules.

The innovation inherent in the invention therefore consists in completely “bypassing” the “accessory” steps previously described, namely:

1—The production of regenerated granules starting from the trimming (continuous, pre-chopped or even pre-ground) in the case of the first system described.
2—The grinding and above all the subsequent treatment of the fluff in the case of the second system described.

The structural and functional characteristics of the invention and its advantages with respect to the known art can be more clearly understood from the following description, referring to the attached drawings, which illustrate a possible non-limiting embodiment of the invention itself.

In the drawings:

FIG. 1 schematically illustrates a plant for the recovery of trimmings by re-granulation (or “regeneration”) in a specific extruder, said plant being produced according to the known art;

FIG. 2 schematically illustrates a plant for the recovery of trimmings by grinding the trimmings in a so-called “mill” and subsequent feeding into an extruder of the production line by means of suitable systems, said plant being produced according to the known art;

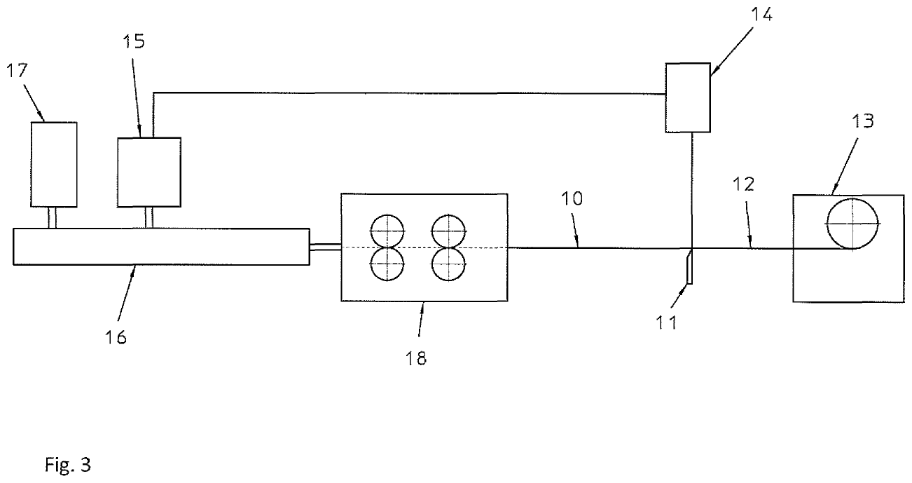

FIG. 3 schematically illustrates a trimming recovery plant according to the present invention;

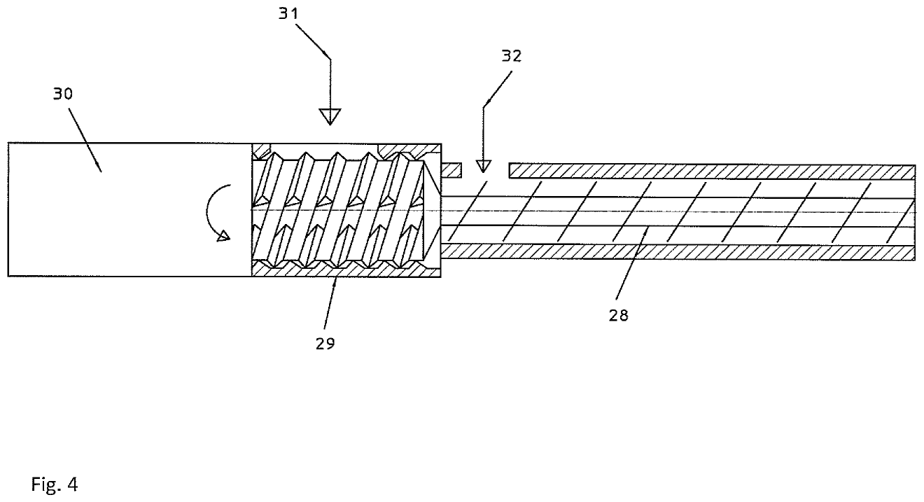

FIG. 4 shows a shredder positioned directly and coaxially with respect to the extruder according to the present invention;

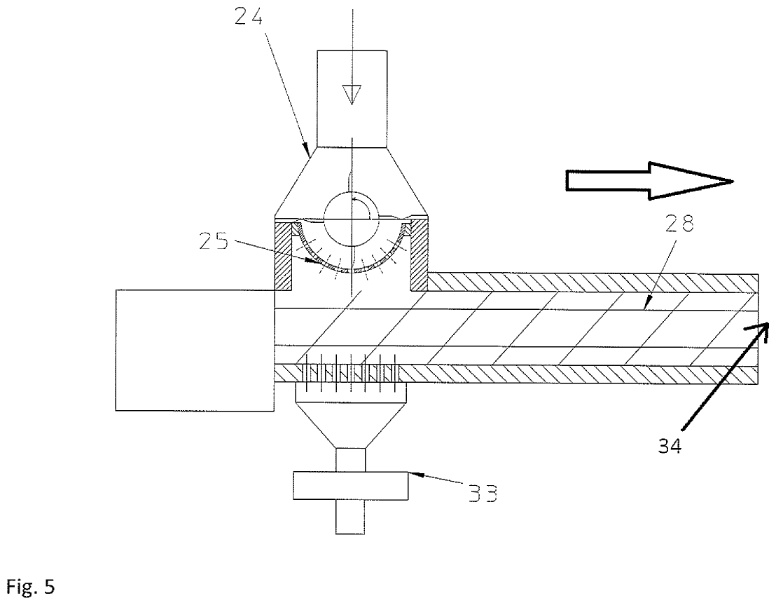

FIG. 5 illustrates a grinding mill applied orthogonally with respect to the movement direction of the melt in the extruder and in the feeding system of the extruder itself according to the present invention.

With reference to FIG. 3:
reference number 10 indicates a film (of any type) complete with trimmings;
reference number 11 indicates a device for cutting the trimmings (which, as is known, can have various embodiments);
reference number 12 indicates the film net of trimmings;
reference number 13 indicates a device for winding or in any case for “collecting” the film produced;
reference number 14 indicates a device for conveying the trimmings (which, as is known, can have various embodiments);
reference number 15 indicates a device for the “pre-treatment” of the trimmings (chopping or grinding);
reference number 16 indicates an extruder for treating said trimmings;
reference number 17 indicates a device for dosing and feeding the granules into said extruder;
reference number 18 indicates a device for forming the film (produced according to a known embodiment).

According to the present invention, the plant for the on-line recovery of trimmings in extrusion lines of plastic material 10 comprises:
a device 11 for cutting side portions, so-called trimmings, from a film 10 of plastic material leaving a device 18 for forming said film 10;
means 14 for conveying said trimmings positioned downstream of said cutting device 11;
an extruder 16 for treating said trimmings;
a device 17 for dosing and feeding granules for the formation of the plastic film in said extruder 16, said extruder 16 and said device 17 for dosing and feeding granules being positioned upstream of said device 18 for the formation of said film 10.

Said pre-treatment device 15 is provided in combination with said extruder 16.

In an embodiment, at the inlet of said extruder 16, a pre-treatment device 15 of the trimmings is provided, obtained by cutting side portions of said film 10 and conveyed to said pre-treatment device 15 by said conveying means 14.

According to the present invention, said pre-treatment device 15 is a pre-chopping and/or pre-grinding device for said trimmings.

Said pre-treatment device 15 is in line with the devices 16,17,18 for the production of said plastic material 10.

As illustrated in FIG. 3, said pre-chopping or pre-grinding device 15 of the continuous trimming is provided before it enters the extruder 16.

The presence of said device 15 essentially creates the possibility of guaranteeing an adequate constancy of feeding of the extruder, which obviously proves to be strongly influenced by the considerable difference in density that is found between the virgin granule (whose feeding must in any case be guaranteed independently) and the trimming.

More specifically, for production lines in which the quantity of trimming is significant, this pre-chopping or pre-grinding device 15 is important, as the percentage ratio between the quantity of trimming fed and the granule dosed in the extruder can be high.

For applications typically (but not exclusively) on lines that use the so-called “cast” technology, in fact, the percentage of trimming can reach very significant levels; in this case, in order to ensure a correct feeding of the extruder (or to the extruders) destined for the recovery of the trimming, it is preferable to pre-chop or pre-grind said continuous trimmings, so as to considerably increase their density with respect to that of the granule.

This pre-chopping or pre-grinding device 15 can have the most varied construction forms, as it can be represented by a real grinding mill or by a so-called densifier, or again by a shredder, the latter solution preferably, but not exclusively, providing for its positioning coaxially with the extruder itself, so as to provide not only for the chopping of the trimming, but also for conveying (or “forcing”) it into the extruder 16.

The pre-chopping or pre-grinding device 15 can be directly or indirectly connected to the extruder 16. In the case of an indirect connection, the two devices are separate, whereas in the case of a direct connection, the two devices form a single element.

In particular, this latter solution is particularly suitable for the purpose, as it allows a further compacting of the whole, at the same time guaranteeing an efficient feeding constancy.

In this case, the shredder is generally composed as represented in FIG. 4, which illustrates an extrusion screw 28 directly and coaxially connected to the so-called shredder 29, which can be rotated by the same motor 30 or by two different motors.

An inlet 31 is therefore present for feeding the trimming (possibly already pre-chopped by means of a multi-cutter system), conveyed by any transporting means 14, and simultaneously also an inlet 32 for the feeding of the granule, which can take place either by gravity (i.e. directly applying a storage hopper in correspondence with said inlet 32) or by means of a dosage screw.

Finally, the granule can also be fed directly, again by means of a storage hopper, from the mouth of the inlet 31 of the trimming, so as to also ensure a certain pre-mixing of these two elements.

In any case, the common feature of the above-mentioned pre-chopping or pre-grinding devices 15 is to allow a considerable increase in the apparent density of the trimming, so as to allow its direct feeding into the extruder 16, without the risk of creating “bridges” in the feeding and therefore having the possibility of obtaining a correct hydraulic seal on the mouth of the extruder 16, without the need for using particular or sophisticated forcing systems, and above all completely eliminating problems linked to the transporting and treatment of the dust inevitably produced in this phase.

According to a further embodiment, a real grinding mill, of the type described above, can be applied on the feeding mouth of the extruder 16.

Said grinding mill 24 comprises a rotor equipped with a series of rotating blades which impart a cutting action on the trimming, thanks to the presence of a second series of fixed blades anchored directly to the structure of the extruder 16.

An example of this grinding mill is illustrated in FIG. 5, which also illustrates, in addition to the mill 24 and relative grid 25, a possible fan 33 positioned below the extruder 16 and specifically below the extruder 16 and in correspondence with the feeding inlet of the mill 24 to the extruder 16. The fan 33 is suitable for sucking the ground trimming and preventing it from creating a “bridge” which prevents a correct feeding. Said fan 33, when present, has the particular function of preventing the ground material from remaining too long in correspondence with the grid 25. This would in fact lead to an overheating of the material with the formation of a molten layer which would block the passage holes of said grid 25.

The presence of a fan 33, on the other hand, which acts as a sucker in said position, avoids the overheating of the ground material and has no contraindications as there is no presence of melt in the feeding area of the extruder 16 but only, possibly, granule in the solid state, obviously in addition to the ground material coming from the mill 24.

FIG. 5 shows in particular the movement direction of the molten mass with the arrow, and the outlet point of the same from the extruder, which can be connected to a filter-change system, to a die or to whatever else is necessary, not shown in the figure.

The object of the present invention also relates to a method for the online recovery of trimmings in extrusion lines of film made of plastic material 10.

Said method, according to the present invention, comprises the following steps:
cutting, by means of a cutting device 11, side portions, so-called trimmings, from a film 10 made of plastic material leaving a device 18 for the formation of said film 10;
conveying said trimmings leaving said cutting device 11;
treating said trimmings inside an extruder 16;
dosing and feeding granules for the formation of the film made of plastic material in said extruder 16, said extruder 16 and the device 17 for the dosage and feeding of granules positioned upstream of said device 18 for the formation of said film 10,
   the pre-treatment step of the trimmings obtained from cutting side portions of said film 10 is provided in combination with the production of the film in the extruder 16.

In particular, the pre-treatment step consists of the pre-chopping and/or pre-grinding of said trimmings.

As described above, the pre-treatment step is in line with the steps for the production of said film made of plastic material 10.

The plant object of the present invention appears as extremely compact and above all completely eliminates the limits and defects of the two plants previously analyzed, i.e.:

a) With respect to regeneration, the energy consumption is practically zero, as the power used for the reprocessing of the trimmings is spent directly for the production of part of the finished product, and not for a “semi-finished” product (i.e. the granule) which is then subsequently re-extruded; the only additional energy consumption with respect to a common extruder is represented by the conveying system of the trimmings and by the pre-grinder, but in both cases these are power values used well below those present in the two known plants described above and illustrated in FIGS. 1 and 2.

b) With respect to regeneration, no additional operator is required, as the extruder 16 is an integral part of the production line, for which one or more operators are already destined.
c) With respect to regeneration, there is no risk of degradation of the material, which is reprocessed only once and therefore does not significantly change its chemical-physical characteristics, making it completely similar from this point of view to the recovery system with a grinding mill.
d) With respect to regeneration, as there is no need to cool the granule produced (as, thanks to the present invention, there is no production of granules from trimmings), there is no need for an independent cooling system and possible subsequent drying.
e) With respect to regeneration, there is no problem with the overall dimensions of the plant, as this is “incorporated” by the production line, which does not significantly change its overall dimensions in plan or raised views.
f) With respect to regeneration, there is no risk of supply irregularity, as the more constant the production of the entire extrusion line, the more constant the quantity of trimming is, and in any case even in the event of undesired or unavoidable variations, there is the possibility of compensating the missing flow-rate with a dosage of granule (device 17 illustrated in FIG. 3). Furthermore, the presence of a pre-grinding or pre-chopping device 15 completely solves this problem.
g) With respect to the recovery of fluff, there is no generation of dust as, due to the plant conformation, there is no need for conveying the broken or ground trimming, which is charged directly into the extruder 16.
h) With respect to the recovery of fluff, there is no need to create any hydraulic seal on the mouth of the extruder 16, as the trimming is substantially “pushed” into the same by the same chopping or grinding device 15.
i) With respect to the recovery of fluff, the feeding constancy derives specifically from the fact that, as there is no type of conveying of the chopped or ground trimming from the chopping or grinding device to the extruder, there is no possibility of creating any type of “accumulation” or stagnation, therefore the constancy of the flow-rate is nevertheless guaranteed.
j) With respect to the recovery of fluff, the overall dimensions are substantially zero, since, as already stated, the extruder 16 which recovers the trimming is an integral part of the production line and consequently does not require the addition of any other type of plant or device, apart from the primary conveying device of the trimming, which in any case represents a truly negligible encumbrance with respect to the rest of the extrusion line, of whatever type it may be.

The objectives of the invention mentioned in the preamble of the description have thus been achieved.

The protection scope of the present invention is defined by the enclosed claims.

The invention claimed is:

1. A plant for online recovery of trimmings in an extrusion line of a film made of a plastic material (10), comprising:
a cutting device (11) configured to cut trimmings shaped as side portions, from the film (10) made of the plastic material leaving a forming device (18) configured to form said film (10);
a conveying apparatus (14) configured to convey said trimmings, said apparatus being positioned downstream of said cutting device (11);
an extruder (16) configured to treat said trimmings;
a dosing and feeding device (17) configured to dose and feed granules for formation of the film made in said extruder (16), said extruder (16) and said dosing and feeding device (17) being positioned upstream of said forming device (18); and
a pre-treatment device (15) configured to pre-treat the trimmings of said film (10) conveyed to said pre-treatment device (15) by said conveying apparatus (14), said pre-treatment device being provided at an inlet of said extruder (16), said pre-treatment device (15) comprising a shredder positioned coaxially with respect to said extruder (16).

2. The plant according to claim 1, wherein said pre-treatment device (15) is a device configured to pre-chop and/or pre-grinding said trimmings.

3. The plant according to claim 1, wherein said pre-treatment device (15) is in line with the extruder, the dosing and feeding device and the forming device (16,17,18).

4. The plant according to claim 1, wherein said pre-treatment device (15) comprises a grinding mill or a densifier.

5. The plant according to claim 1, wherein said pre-treatment device (15) comprises the shredder directly connected to said extruder (16).

6. The plant according to claim 1, wherein an extrusion screw (28) of the extruder (16) is connected directly or coaxially with said shredder (29), said shredder (29) and said extrusion screw (28) being controlled by a same motor or by two different motors, said extruder (16) being provided with at least one inlet (31,32) for feeding the granules and/or the trimmings.

7. The plant according to claim 1, wherein said pre-treatment device (15) comprises a grinding mill (24) positioned on a feeding mouth of the extruder (16).

8. The plant according to claim 7, wherein said grinding mill (24) comprises a rotor bearing a plurality of rotating blades that impart a cutting action on the trimmings due to a second plurality of fixed blades, anchored directly to a structure of the extruder (16).

9. The plant according to claim 7, further comprising a fan (33) provided beneath the feeding mouth of said extruder (16), said fan being configured to suck ground trimmings in order to ensure a correct feeding to form said film made of the plastic material (10).

10. The plant according to claim 1, further comprising a pre-chopping device of the trimmings provided upstream of said pre-treatment device (15) of the trimmings.

11. A method of online recovery in an extrusion line of a film made of a plastic material (10), comprising:
cutting, with a cutting device (11), trimmings, shaped as side portions, from the film (10) made of the plastic material leaving a forming device (18) of said film (10);
conveying said trimmings leaving said cutting device (11);
treating said trimmings inside an extruder (16);
dosing and feeding granules for formation of the film made of the plastic material in said extruder (16), said extruder (16) and a dosing and feeding device (17) of the granules being upstream of said forming device (18),
further comprising a step of pre-treating the trimmings obtained from cutting the side portions of said film (10) upstream of producing the film in the extruder (16).

12. The method according to claim 11, wherein the step of pre-treating comprises pre-chopping and/or pre-grinding said trimmings.

13. The method according to claim 11, wherein the step of pre-treating is performed in line with producing said film made of the plastic material (10).
